(19) United States
(12) Patent Application Publication
(10) Pub. No.: US 2020/0400954 A1
(43) Pub. Date: Dec. 24, 2020

(54) IMAGE DISPLAY SYSTEM, IMAGE DISPLAY METHOD, AND WEARABLE DISPLAY DEVICE

(71) Applicants: Satomi Tanaka, Kanagawa (JP); Shigenobu Hirano, Kanagawa (JP); Yasuo Katano, Kanagawa (JP); Kenji Kameyama, Kanagawa (JP); Norikazu Igarashi, Kanagawa (JP)

(72) Inventors: Satomi Tanaka, Kanagawa (JP); Shigenobu Hirano, Kanagawa (JP); Yasuo Katano, Kanagawa (JP); Kenji Kameyama, Kanagawa (JP); Norikazu Igarashi, Kanagawa (JP)

(21) Appl. No.: 16/890,173

(22) Filed: Jun. 2, 2020

(30) Foreign Application Priority Data
Jun. 24, 2019 (JP) 2019-116783

(51) Int. Cl. G02B 27/01; G02B 27/00

(52) U.S. Cl. CPC G02B 27/0172; G02B 2027/014; G02B 2027/0138; G02B 27/0093

(57) ABSTRACT

An image display system includes a wearable display device configured to display an image to a person wearing the wearable display device, the wearable display device mountable on a head of the person; an image capture unit configured to capture an image of a face of the person wearing the wearable display device; and circuitry configured to extract one or more facial feature points of the person based on the image captured by the image capture unit; calculate a position of the head of the person and a posture of the person based on the one or more extracted facial feature points to generate position-posture information; and generate an image to be displayed at the wearable display device based on the position-posture information.

### CROSS-REFERENCE TO RELATED APPLICATION

This application claims priority pursuant to 35 U.S.C. § 119(a) to Japanese Patent Application No. 2019-116783, filed on Jun. 24, 2019 in the Japan Patent Office, the disclosure of which is incorporated by reference herein in its entirety.

### BACKGROUND

### Technical Field

This disclosure relates to an image display system, an image display method, and a wearable display device.

### Background Art

Image display devices, such as head-mountable image display devices, can be attached on heads of persons so that the persons can view images using the head-mountable image display devices. When the head-mountable image display device is a transparent-type head-mountable image display device attached on a head of person, the person can view images displayed on the head-mountable image display device while observing the real space surrounding the person, in which the position and direction of the head-mountable image display device in the real space is required to be acquired using any means.

For example, a portable terminal equipped with a camera can be used to capture images of user attached with the head-mountable image display device to detect a change of feature value of the head-mountable image display device, such as the position of the head-mountable image display device to estimate the position and direction of the head-mountable image display device.

However, a special code or object are required to be equipped to the head-mountable image display device to extract the feature value of the head-mountable image display device. Therefore, there are restrictions on design of the head-mountable image display device, such as shape and appearance of the head-mountable image display device.

### SUMMARY

As one aspect of the present disclosure, an image display system is devised. The image display system includes a wearable display device configured to display an image to a person wearing the wearable display device, the wearable display device mountable on a head of the person; an image capture unit configured to capture an image of a face of the person wearing the wearable display device; and circuitry configured to extract one or more facial feature points of the person based on the image captured by the image capture unit; calculate a position of the head of the person and a posture of the person based on the one or more extracted facial feature points to generate position-posture information; and generate an image to be displayed at the wearable display device based on the position-posture information.

As another aspect of the present disclosure, a method of displaying an image is devised. The method includes extracting one or more facial feature points of a person wearing a wearable display device based on an image captured by an image capture unit; calculating a position of a head of the person and a posture of the person based on the one or more extracted facial feature points to generate position-posture information; and generating an image to be displayed at the wearable display device based on the calculated position-posture information including position information of the head of the person and posture information of the person.

As another aspect of the present disclosure, a wearable display device is devised. The wearable display device includes circuitry configured to calculate a position of a head of a person and a posture of the person based on one or more facial feature points of the person wearing the wearable display device, based on an image captured by an image capture unit to generate position-posture information; generate an image to be displayed at the wearable display device based on the calculated position-posture information; and display the generated image, on a display.

### BRIEF DESCRIPTION OF THE DRAWINGS

A more complete appreciation of the description and many of the attendant advantages and features thereof can be readily acquired and understood from the following detailed description with reference to the accompanying drawings, wherein:

FIG. 1 illustrates an example of a block diagram of a hardware configuration of an information terminal used for an image display system according to a first embodiment;

FIG. 2 illustrates an example of a block diagram of a hardware configuration of of a wearable display device used for the image display system according to the first embodiment;

FIG. 3 illustrates an example of a block diagram of a functional configuration of the image display system according to the first embodiment;

FIG. 4 illustrates an example of operation of the image display system according to the first embodiment;

FIGS. 5A, 5B, 5C, and 5D illustrate a method of extracting facial feature points and estimating a position and a posture using the image display system according to the first embodiment;

FIGS. 6A, 6B, 6C, 6D, 6E, and 6F illustrate examples of extracting facial feature points using the image display system according to the first embodiment;

FIG. 7 is a flowchart illustrating an example of image display processing in the image display system according to the first embodiment;

FIG. 8 illustrates an example of a block diagram of a functional configuration of an image display system according to a second embodiment;

FIG. 9 illustrates an example of operation of the image display system according to the second embodiment;

FIG. 10 illustrates an example of a block diagram of a functional configuration of an image display system according to a modification example of the second embodiment;

FIG. 11 illustrates an example of a block diagram of a hardware configuration of of a full-view spherical image capture apparatus applied to an image display system according to a third embodiment;

FIG. 12 illustrates an example of a block diagram of a functional configuration of an image display system according to the third embodiment;

FIG. 13 illustrates an example of operation of the image display system according to the third embodiment;

FIG. 14 illustrates an example of a block diagram of a functional configuration of an image display system according to a modification example of the third embodiment; and

FIG. 15 illustrates an example of a block diagram of a functional configuration of an image display system according to a fourth embodiment.

The accompanying drawings are intended to depict embodiments of the this disclosure and should not be interpreted to limit the scope thereof. The accompanying drawings are not to be considered as drawn to scale unless explicitly noted.

### DETAILED DESCRIPTION

A description is now given of exemplary embodiments of the present inventions. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, region, layer or unit discussed below could be termed a second element, component, region, layer or unit without departing from the teachings of the present inventions.

In addition, it should be noted that the terminology used herein is for the purpose of describing particular embodiments only and is not intended to be limiting of the present inventions. Thus, for example, as used herein, the singular forms “a”, “an” and “the” are intended to include the plural forms as well, unless the context clearly indicates otherwise. Moreover, the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Hereinafter, a description is given of one or more embodiments with reference to the drawings.

### First Embodiment

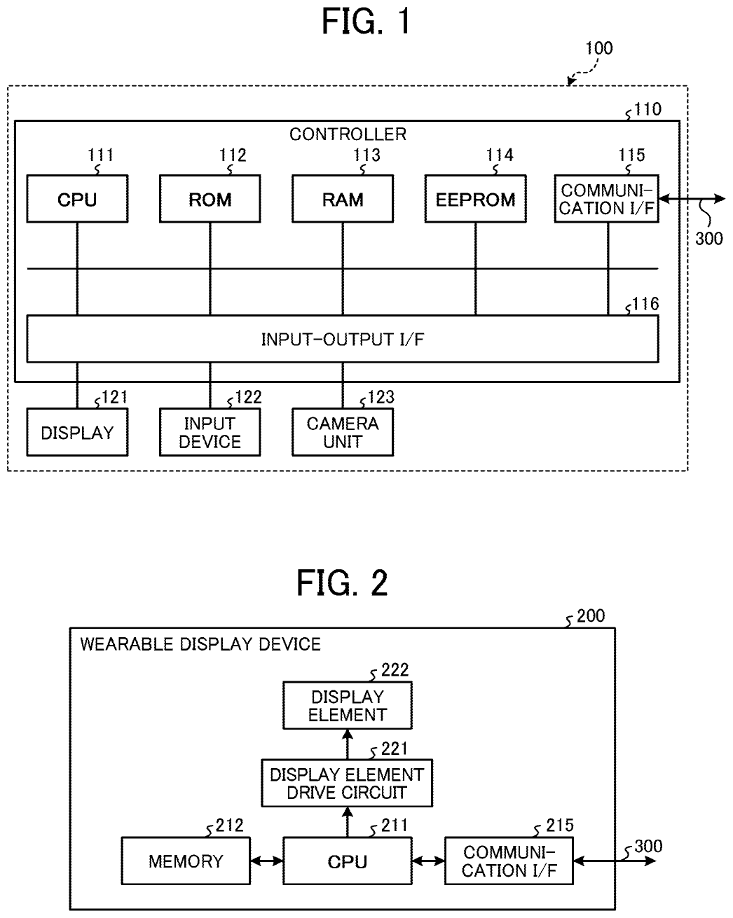

Hereinafter, a description is given of a first embodiment with reference to FIGS. 1 to 7. In a configuration of an image display system of the first embodiment, a camera mounted on an information terminal captures an image of face of user (person) mounting a wearable display device, such as glass-type wearable display device. Further, in the configuration of the image display system of the first embodiment, a positional relationship between the user face and the information terminal, and a posture of user are recognized or determined based on the image captured by the camera. Based on the captured image and the recognized positional relationship between the user face and the information terminal and the posture of user, one or more objects in a virtual space are displayed at the wearable display device.

### (Hardware Configuration of Image Display System)

The image display system of the first embodiment includes, for example, an information terminal and a wearable display device, such as glass-type wearable display device. However, the wearable display device is not limited to the glass-type wearable display device, but can be any wearable display device, such as visor type wearable display device. Hereinafter, a description is given of hardware configuration of each of the information terminal and the wearable display device with reference to FIGS. 1 and 2.

FIG. 1 illustrates an example of a block diagram of a hardware configuration of of an information terminal 100 used for the image display system according to the first embodiment. The information terminal 100 is a computer, such as smart phone, tablet type terminal, and note personal computer (PC).

As illustrated in FIG. 1, the information terminal 100 includes, for example, a controller 110, a display 121, an input device 122, and a camera 123, which are connected to the controller 110 by wire, wirelessly, or both of them.

The controller 110 controls the information terminal 100 entirely. The controller 110 includes, for example, a central processing unit CPU) 111, a read-only memory (ROM) 112, a random access memory (RAM) 113, an electrically erasable programmable read-only memory (EEPROM) 114, a communication interface (I/F) 115, and an input-output interface (I/F) 116.

The CPU 111 controls the operation of the information terminal 100 by executing the control programs stored in the ROM 112.

The ROM 112 stores the control programs for controlling the data managing and peripheral modules collectively, performed by the CPU 111.

The RAM 113 is used as a work memory that is required for the CPU 111 to execute the control programs. The RAM 113 is also used as a buffer for temporarily storing information acquired via the camera 123.

The EEPROM 114 is a nonvolatile ROM that stores essential data, for example, even when the power is turned off, such as essential setting information of the information terminal 100.

The communication I/F 115 is an interface that communicates with an external device, such as the wearable display device. A cable 300, such as high-definition multimedia interface (HDMI: registered trademark) cable, is connected to the communication I/F 115.

The input-output I/F 116 is an interface that transmits and receives signals between various devices provided in the information terminal 100, such as the display 121, the input device 122, and the camera 123, and the controller 110.

The display 121 displays, for example, characters, numbers, various screens, operation icons, and images acquired by the camera 123.

The input device 122 performs various operations, such as character and number input, selection of various instructions, and cursor movement. The input device 122 may be a keypad provided in a housing of the information terminal 100, or may be a device, such as mouse or keyboard.

The camera 123 is one unit disposed for the information terminal 100. For example, the camera 123 can be provided on the same side of the display 121. The camera 123 can be, for example, an red/green/blue (RGB) camera, a web camera that can capture color images, or the camera 123 can be a RGB-D (depth) camera or a stereo camera having a plurality of cameras that can acquire distance or range information of one or more objects.

FIG. 2 illustrates an example of a block diagram of a hardware configuration of of a wearable display device 200 used for the image display system according to the first embodiment. The wearable display device 200 is, for example, a transparent-type head mount display (HMD), which can be used as a head-mountable image display device. The transparent-type HMD may be also referred to as the transparent HMD or see-through HMD.

As illustrated in FIG. 2, the wearable display device 200 includes, for example, a CPU 211, a memory 212, a communication I/F 215, a display element drive circuit 221, and a display element 222.

The CPU 211 controls the operation of the wearable display device 200 entirely using a RAM area of the memory 212 as a work memory for executing one or more programs stored in a ROM area of the memory 212 in advance.

The memory 212 includes, for example, the ROM area and the RAM area.

The cable 300 is connected to the communication I/F 215. The communication I/F 215 transmits and receives data between the information terminal 100 via the cable 300.

The display element drive circuit 221 generates display drive signals used for driving the display element 222 in accordance with the display control signals received from the CPU 211. The display element drive circuit 221 feeds the generated display drive signals to the display element 222.

The display element 222 is driven by the display drive signals supplied from the display element drive circuit 221. The display element 222 includes, for example, a light modulating element, such as liquid crystal element or organic electro luminescence (OEL) element, which modulates light emitted from a light source for each pixel in accordance with an image as imaging light. The imaging light modulated by the light modulating element is irradiated to the left eye and right eye of user wearing the wearable display device 200. The imaging light and external light are synthesized and then becomes incident light to the left eye and right eye of the user. The external light indicating an external scene is a light directly transmitted through a lens of the wearable display device 200 that has a half-mirror when the wearable display device 200 is an optical transmission-type display device. If the wearable display device 200 is a video transmission-type display device, the external light is a video image captured by a video camera disposed for the wearable display device 200.

### (Functional Configuration of Image Display System)

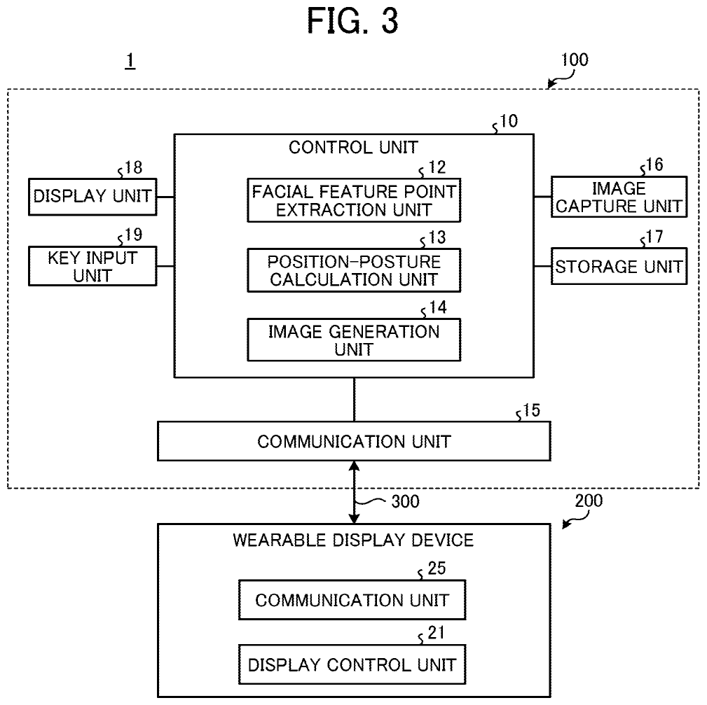

FIG. 3 illustrates an example of a block diagram of a functional configuration of an image display system 1 according to the first embodiment. As illustrated in FIG. 3, the image display system 1 includes, for example, the information terminal 100 having an image capture unit 16, and the wearable display device 200. The information terminal 100 and the wearable display device 200 are connected to each other by the cable 300, such as high-definition multimedia interface (HDMI) cable.

The information terminal 100 includes, for example, a control unit 10, a communication unit 15, an image capture unit 16, a storage unit 17, a display unit 18, and a key input unit 19. These units are communicatively connected to each other.

The communication unit 15 is a module that connects to a line to communicate with another terminal device or server system. Further, the communication unit 15 is connected to the cable 300 to transmit image information or the like to the wearable display device 200. The communication unit 15 is, for example, implemented by the communication IN 115 of FIG. 1.

The image capture unit 16 is a module having an optical system and an image-receiving element, which provides a function of acquiring digital image. The image capture unit 16 generates image data, from image of an object captured and acquired by the optical system, under the set image capture condition, and stores the generated image data in the storage unit 17. The image capture unit 16 is implemented, for example, by the camera 123 of FIG. 1.

The display unit 18 displays various screens. The display unit 18 is implemented, for example, by the display 121 and the program executed by the CPU 111 of FIG. 1. If the display 121 is a touch panel, the input device 122 may be included as a hardware for implementing the display unit 18.

The storage unit 17 is a memory, which stores information under the control of the control unit 10, and provides the stored information to the control unit 10. Further, the storage unit 17 stores various programs executable by the control unit 10, and the control unit 10 reads and executes the various programs as needed. Further, the storage unit 17 stores augmented reality information, information of displaying augmented reality information for each graphic object, and information of not displaying augmented reality information for each graphic object, to be described later. The storage unit 17 is implemented, for example, by the ROM 112 the RAM 113, and the EEPROM 114 of FIG. 1.

The control unit 10 controls the operation of respective each unit to perform various information processing. The control unit 10 is a functional unit, which is implemented by executing the program stored in the storage unit 17 by the CPU 111 of FIG. 1. The control unit 10 performs or implements various functions of the information terminal 100 by exchanging data and control signals between the communication unit 15, the image capture unit 16, the storage unit 17, the display unit 18, and the key input unit 19 of the information terminal 100.

The control unit 10 further includes, for example, functional units, such as a facial feature point extraction unit 12, a position-posture calculation unit 13, and an image generation unit 14.

The facial feature point extraction unit 12 recognizes a face of user from images including face images of persons including the user, captured by the image capture unit 16, and extracts one or more facial feature points (hereinafter, facial feature point).

The position-posture calculation unit 13 calculates a position of user head and a posture of user based on the facial feature point extracted by the facial feature point extraction unit 12. With this configuration, the position-posture calculation unit 13 generates position-posture information including position information of user head and posture information including user posture information.

The image generation unit 14 generates one or more images to be displayed at the wearable display device 200 based on the position-posture information calculated by the position-posture calculation unit 13. The image generation unit 14 transmits the generated image to the wearable display device 200 via the communication unit 15.

As illustrated in FIG. 3, the wearable display device 200 includes, for example, a display control unit 21, and a communication unit 25.

The communication unit 25 receives one or more images to be displayed on the wearable display device 200 from the information terminal 100. The communication unit 25 is implemented, for example, by the communication I/F 215 of FIG. 2.

The display control unit 21 displays one or more images at the wearable display device 200 based on the image received via the communication unit 25 to show the one or more images to a user. The display control unit 21 is implemented, for example, by the display element driving circuit 221, the display element 222, and the program executed by the CPU 211 of FIG. 2.

### (Operation of Image Display System)

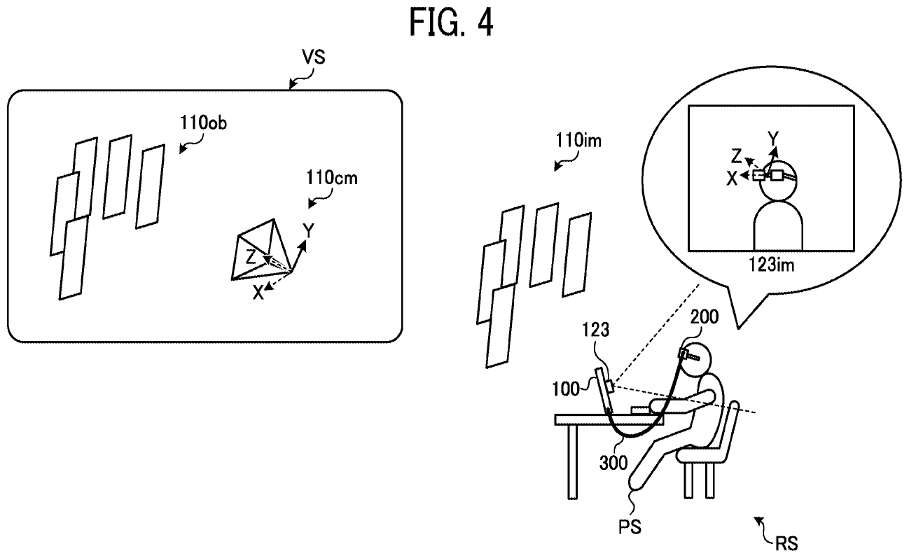

Hereinafter, a description is given of example of operation of the image display system 1 with reference to FIGS. 4 to 6. FIG. 4 illustrates an example of operation of the image display system 1 according to the first embodiment.

As illustrated in FIG. 4, a user PS wears the wearable display device 200 in the image display system 1. The information terminal 100 having the camera 123 is disposed at a position where the camera 123 can capture a face image of the user PS wearing the wearable display device 200, such as a front side of the user PS. The wearable display device 200 and the information terminal 100 are connected each other by the cable 300.

The camera 123 (image capture unit 16) of the information terminal 100 captures images including the face image of the user PS wearing the wearable display device 200. FIG. 4 illustrates a captured image 123im, which is captured by the camera 123.

The facial feature point extraction unit 12 extracts the facial feature point of the user PS from the captured image 123im. The position-posture calculation unit 13 calculates position information of a head of the user PS and posture information of the user PS based on a change of the position of the facial feature point extracted by the facial feature point extraction unit 12.

The position information of the head of the user PS is expressed, for example, in the XYZ coordinate space using a position of the camera 123 as a reference point. The X axis indicates an inclination of face of the user PS in the left-to-right direction, the Y axis indicates the vertical position of the face of user PS, and the Z axis indicates a distance of the user PS from the camera 123. The posture information of the user PS is indicated by an angle formed by the X axis and Y axis in the XYZ coordinate space used for defining the position information.

Further, as illustrated in FIG. 4, a virtual object 110ob is set in a virtual space VS. The virtual object 110ob is captured by a virtual camera 110cm, such as rendering camera, and the virtual object 110ob is displayed at the wearable display device 200 to show the virtual object 110ob to the user PS. More specifically, the image generation unit 14 generates an image to be displayed at the wearable display device 200 by controlling the virtual camera 110cm, and then the virtual object 110ob is projected as a virtual space image 110im in a real space RS where the user PS exists, and then the virtual object 110ob is shown to the user PS in real time as illustrated in FIG. 4. In this situation, the image generation unit 14 matches a viewing angle of the wearable display device 200, which is estimated from the position-posture information generated by the position-posture calculation unit 13, and an angle of view of the virtual camera 110cm. Further, the image generation unit 14 changes a position and direction of the virtual camera 110cm based on a change of the position-posture information. With this configuration, images can be drawn and projected as if the user PS directly observes the virtual space VS.

The above described technology of displaying scenes of the real space RS together with the virtual space images 110im at the wearable display device 200 is known as augmented reality (AR) technology.

The above-described extraction of the facial feature point, estimation of position and posture, and generation of image by operating the virtual camera 110cm can be implemented by, for example, an application, such as Unity. Unity is an application provided by Unity Technologies, which can be used as a three dimensional (3D) rendering tool.

When the application of Unity is activated, as an initial setting of rendering, the matching of the angle of view of the virtual camera 110cm and the viewing angle of the wearable display device 200 is performed.

Further, the calibration is performed to take into account a distance between an eyeball of the user PS and a lens of the wearable display device 200, and an individual difference of pupil interval of the user PS. The calibration can be performed, for example, using kwon technology, such as the technology disclosed in JP-2014-106642-A.

Specifically, a virtual space image 110im, such as a rectangular image frame of a given size, is displayed on the wearable display device 200, to show the virtual space image 110im to the user PS wearing the wearable display device 200. In this state, a position of the head of the user PS is moved so that the frame of the display 121 of the information terminal 100 existing in the real space RS and the rectangular image frame of the virtual space image 110im are aligned with each other.

When the frame of the display 121 and the rectangular image frame of the virtual space image 110im are aligned with each other, a distance between the camera 123 of the information terminal 100 and the head of the user PS become constant, in which the facial feature point extraction unit 12 and the position-posture calculation unit 13 calculate the distance between the camera 123 of the information terminal 100 and the head of the user PS based on the face recognition data of the user PS at this time as reference data to calculate the distance in a time series.

Further, after this timing, the image capturing operation of the user PS performed by the camera 123 of the information terminal 100 continues, and then the facial feature point extraction unit 12 continuously extracts the facial feature point of the user PS from the captured images, and the position-posture calculation unit 13 continuously calculates the position and posture of the user PS. The position and direction of the virtual camera 110cm in the virtual space VS are repeatedly reset based on the position-posture information calculated by the position-posture calculation unit 13. With this configuration, for example, if the user PS changes the position and posture of the user head to look around the user PS, the virtual camera 110cm captures the virtual space VS in accordance with the change of the position and posture of head of the user PS

As described above, the application of Unity can easily create one or more virtual objects 110ob in the virtual space VS, and can re-relocate the one or more virtual objects 110ob freely in the virtual space VS. Further, by changing the settings of the virtual camera 110cm, an image that can observe the virtual space VS can be generated freely. By fixing the position and direction of the virtual object 110ob, a display as if the virtual object 100ob exists at a given position in the real space RS can be generated. Further, by changing the position and direction of the virtual object 100ob in accordance with the change of the position and posture of the user PS, a drawing of the virtual object 100ob that follows the transition of the viewpoint of the user PS can be performed.

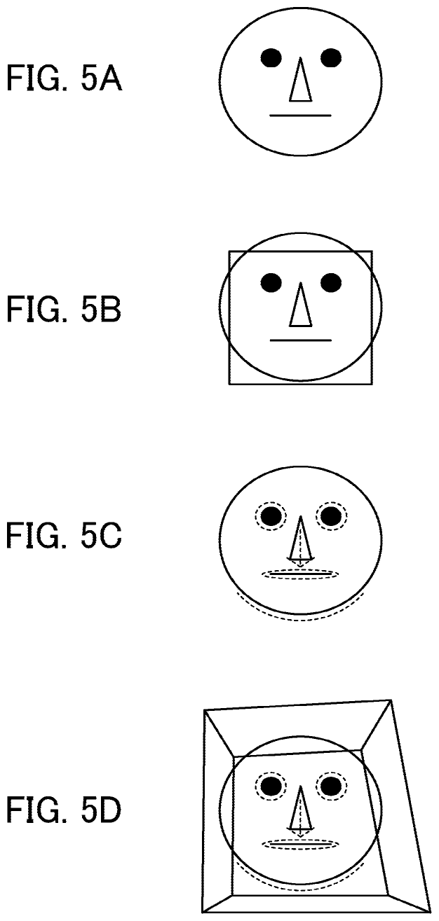

The extraction of facial feature point and estimation of position and posture of the user PS can be performed using, for example, source codes of OpenFace, which is an open library of C++ for the facial image analysis. The OpenFace can be referred to, for example, Tabas Baltrusaitis, et al., “OpenFace: an open source facial behavior analysis toolkit,” TCCV 2016. FIG. 5 illustrates a method of extracting the facial feature point and estimating the position and postures using OpenFace.

FIGS. 5A, 5B, 5C, and 5D illustrate a method of extracting the facial feature point and estimating the position and posture using the image display system 1. FIG. 5A is an image including a face of the user PS captured by the camera 123. As illustrated in FIG. 5B, the facial feature point extraction unit 12 detects a face portion of the user PS, and then, as illustrated in FIG. 5C, the facial feature point extraction unit 12 uses OpenFace technique to extract a given number of points from eyes, mouth, eyebrows, and face couture as landmark of the user PS using conditional local neural field (CLNF) feature value. As to the method of OpenFace, for example, the position and posture of head, the gaze direction, and the facial expression can be estimated from 68 points. As illustrated in FIG. 5D, in the image display system 1, the position-posture calculation unit 13 calculates position-posture information of the head.

As to the method of OpenFace, the position-posture calculation unit 13 calculates an estimation value of the position-posture information of the head as a position and a posture in the coordinate system that sets the camera 123 that captures images as the reference point. Therefore, in the coordinate system of the virtual space VS, the camera 123 of the information terminal 100 is located at the origin point.

As above described, in order to calculate the position-posture information of the head by the position-posture calculation unit 13, the facial feature point extraction unit 12 needs to extract a given number of points from eyes, mouth, eyebrows, and face couture.

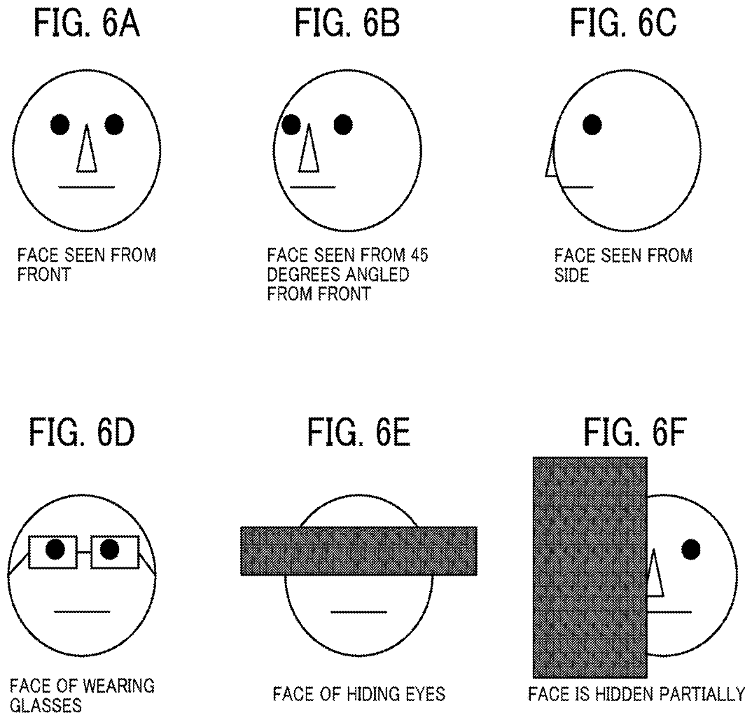

The inventors have found that the detection accuracy of face does not decrease when a face image is captured from the front side (FIG. 6A), when a face image is captured from 45 degrees angled from the front side (FIG. 6B), and when a face image wearing glasses is captured (FIG. 6D). Further, the inventors have found that, even if a face image hiding eyes is captured (FIG. 6E), and a face image partially hidden is captured (FIG. 6F), the detection accuracy of face does not decrease so much if 60% or more feature points can be extracted with respect to the total feature points. Therefore, even if the eye portion is hidden by an eyeglass or the wearable display device 200, the inventors assume that wearing of device may not affect the accuracy of facial feature point extraction and position-posture estimation.

However, in cases when an face image is captured from the side (FIG. 6C) or a face image hidden larger area is captured, the inventors assume that the extraction of feature points with respect to the total feature points becomes less than 60%, and thereby affects the accuracy of facial feature point extraction and position-posture estimation greatly.

### (Example of Image Display Processing)

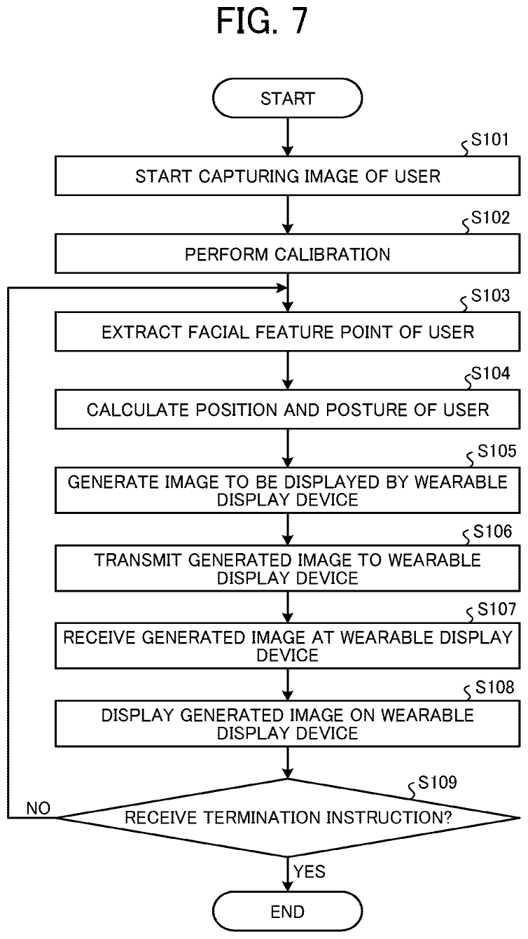

Hereinafter, a description is given of an example of image display processing in the image display system 1 according to the first embodiment with reference to FIG. 7. FIG. 7 is a flowchart illustrating an example of image display processing in the image display system 1 according to the first embodiment.

As illustrated in FIG. 7, the image capture unit 16 of the information terminal 100 starts an image capturing operation of the user PS (step S101).

Then, the control unit 10 of the information terminal 100 performs a calibration (step S102). Specifically, the control unit 10 instructs the communication unit 15 to communicate with the communication unit 25 of the wearable display device 200, and instructs the display control unit 21 of the wearable display device 200 to display the virtual space image 110im, such as a rectangular image frame having a given size.

Then, the image capture unit 16 acquires an image including a face of the user PS when the frame of the display 121 of the information terminal 100 aligns with the rectangular image frame of the virtual space image 110im, when viewed from the user PS.

Then, the facial feature point extraction unit 12 extracts the facial feature point of the user PS from the image captured under this condition.

Then, the position-posture calculation unit 13 registers the facial feature point extracted under this condition as information indicating that a distance between the user PS and the camera 123 is a given distance value. Then, the distance between the user PS and the camera 123 is calculated based on an interval space between the facial feature points extracted under this condition.

After terminating the calibration, the subsequent processing is performed to generate an image to be displayed at the wearable display device 200.

The facial feature point extraction unit 12 extracts the facial feature point of the user PS from the image captured by the image capture unit 16 (step S103).

Then, the position-posture calculation unit 13 calculates the position of the head of the user PS and the posture of the user PS from the facial feature point extracted by the facial feature point extraction unit 12, and then generates the position-posture information of the user PS (step S104).

Then, the image generation unit 14 generates an image to be displayed at the wearable display device 200 based on the position-posture information calculated by the position-posture calculation unit 13 (step S105). That is, the image generation unit 14 aligns the position and posture of the user PS and the position and direction of the virtual camera 110cm in the virtual space VS based on the calculated position-posture information, and instructs the virtual camera 110cm to capture images in the virtual space VS.

Then, the communication unit 15 of the information terminal 100 transmits the image generated by the image generation unit 14 to the communication unit 25 of the wearable display device 200 (step S106).

Then, the communication unit 25 of the wearable display device 200 receives the image generated by the image generation unit 14 (step S107).

Then, the display control unit 21 of the wearable display device 200 displays the image received from the information terminal 100 via the communication unit 25 at the wearable display device 200 (step S108) In the wearable display device 200, the image received from the information terminal 100 is fused with the scene of the real space RS and displayed at the wearable display device 200.

Then, the control unit 10 of the information terminal 100 determines whether or not the termination instruction of the image display processing has been instructed from the user PS or the like (step 109). If the termination instruction of the image display processing is not instructed (step S109: NO), the sequence is repeated from step S103. If the termination instruction of the image display processing is instructed (step S109: YES), the sequence is terminated.

Then, the image display processing in the image display system 1 of the first embodiment is completed.

### Comparison Example

The HMD mounted on a head to view images can display desired images on an image display portion in accordance with a movement of user head, with which the user can view the images having a sense of reality. The HMD includes a transparent-type and a light-shielding-type.

In the transparent-type HMD, the user can observe the surrounding scene even while the HMD is being mounted on the user head. Therefore, the user can avoid collision with an obstacle or the like when the user uses the transparent-type HMD in outdoor or during walking.

On the other hand, the light-shielding-type HMD is configured to cover eyes of the user wearing the light-shielding-type HMD. Therefore, a feeling of immersion in the displayed image increases, but it is difficult for the user to pay attention to the outside environment unless the user removes the HMD from the head and stops viewing the images completely.

When the transparent-type HMD is used to perform the AR technology where real space image and virtual spatial image are fused together, in order to display the virtual space image as if the virtual space image exists in the real space, some means that can obtain the three-dimensional position and direction of the HMD in the real space is required. As a means of obtaining the three-dimensional position and direction of the HMD, a method of attaching a measuring device to the HMD and a method of installing a measuring device outside the HMD can be used.

When the measuring device is attached to the HMD, one method using a unique two-dimensional pattern, such as AR markers is known. In this method, the camera installed on the HMD captures the AR markers set in the external world to extract the feature value, and then the three-dimensional position and direction of the HMD are estimated from a change of the position of the feature value. Therefore, the AR markers are constantly required to be captured by the camera.

When the measuring device is attached to the HMD, another method of capturing images using the camera of the HMD, acquiring the feature value of the surrounding environment from the captured images, and then restoring the three-dimensional shape of the surrounding environment is known. In this method, the generation of the three-dimensional shape of the surrounding environment requires greater processing resources, and the high-resolution and wide-angle three-dimensional (3D) camera is required to obtain image data, and the calculation loads of the viewpoint search when the viewpoint changes greatly becomes heavy.

Further, in any of the above-described methods, since all of the measurement processing and image processing are performed by the HMD, the higher portability of HMD and an environment in which the feature value can be easily extracted are required.

On the other hand, when the measuring device is installed outside the HMD, for example, Oculus Rift (registered trademark) manufactured by Oculus VR, LLC, and HTC Vive (registered trademark) manufactured by HTC can be used. These methods include a large-scale technique irradiating a laser from a base station, and a low-cost simple method using an RGB camera disclosed in WO2016/021252.

Hereinafter, the technique disclosed in WO2016/021252 is described as a comparison example, in which a portable terminal equipped with a camera captures a user wearing the HMD. Then, the three-dimensional position and direction of the HMD is estimated from a change of position of feature value of an appearance of the HMD captured by the camera. However, in this comparison example, when the position and posture are estimated, the shape of the HMD is required to be known, or a special code and object for easily extracting the feature value are required. Therefore, the HMD appearance is difficult to change, and the HMD design is restricted.

In recent years, commercialized transparent-type HMD becomes a lighter and smarter product so that users wearing the transparent-type HMD and surrounding persons may not feel no discomfort of wearing the transparent-type HMD and may not feel a sense of presence of the transparent-type HMD. The technology of comparison example requires structures for sensing the appearance of HMD may not be suitable for the position-posture estimation techniques for the light-weight and smart HMD.

As to the image display system 1 of the first embodiment, the position-posture information of the user PS can be obtained by the facial feature point extraction unit 12 and the position-posture calculation unit 13. Thus, the position of the head of the user PS and the posture of the user PS can be estimated without relying on the shape of the wearable display device 200. With this configuration, the wearable display device 200 does not require to have a structure, shape, and design specialized for the position and posture estimation. Therefore, the first embodiment of the wearable display device 200 can be applied to achieve more sophisticated design of the wearable display device.

As to the image display system 1 of the first embodiment, the wearable display device 200 is, for example, a transparent-type HMD. Therefore, the user wearing the transparent-type HMD can see a display of the virtual space VS while looking the real space RS, so that the user wearing the transparent-type HMD can move around safely compared to the user wearing the non-transparent HMD. Further, tools in the real space RS, such as laptop PC or notepad can be used while the user wears the wearable display device 200 of the first embodiment.

As to the image display system 1 of the first embodiment, the wearable display device 200 can display an augmented reality (AR) image, in which the real space image and the virtual space image 110im are fused. With this configuration, information that is used for instructing, supplementing, and/or guiding, for example, work operations performed in the real space RS can be displayed as the virtual space image 110im at the wearable display device 200. Therefore, compared to displaying these information using other tools such as paper or tablet, there is no need to install or support other tools, and the work operations can be smoothly performed.

As to the image display system 1 of the first embodiment, the facial feature point extraction unit 12 can extract the facial feature point accurately if 60% or more feature points can be extracted with respect to the total feature points. Thus, even if an area of eye of the user PS is covered by, for example, the wearable display device 200, the position of the head of the user PS and the posture of the user PS can be estimated accurately. Therefore, even if the user wears the wearable display device 200, the degradation of the estimation accuracy can be reduced.

As to the image display system 1 of the first embodiment, the image generation unit 14 determines the angle of view, position, and direction of the virtual camera 110cm in the virtual space VS based on the viewing angle of the wearable display device 200 and the position-posture information of the user PS. With this configuration, an image as if the virtual space image 110im exists in the real space can be displayed at the wearable display device 200. Therefore, the user PS wearing the wearable display device 200 can intuitively perform the operation to the virtual space image 110im, and a movement of the viewpoint of observing the virtual space image 110im compared to a case of displaying the virtual space image 110im fixedly.

As to the image display system 1 of the first embodiment, the information terminal 100 having the image capture unit 16 can be a general-purpose terminal used by the user PS, such as smartphone, notebook PC, and tablet terminal. Therefore, the introduction and installation of the image display system 1 can be performed more easily than a case of using a special sensor or the like.

Further, in the above-described first embodiment, the information terminal 100 is provided with the camera 123 as the image capture unit 16, but not limited thereto. For example, an external camera can be used as the image capture unit 16. In this case, it is preferable to transmit images captured by the external camera to the information terminal 100 in real time via a cable, such as HDMI cable, or wirelessly.

Further, in the above described first embodiment, the distance between the camera 123 of the information terminal 100 that was confirmed by performing the calibration is used as the reference distance for estimating the subsequent distance, but the estimation of distance can be performed using other methods. For example, as described above, when the camera 123 is a RGB-D camera or a stereo camera, the distance can be automatically estimated without performing the above-described procedure. Further, the registration of face of user captured from the known distance can be performed in advance, and then the distance can be estimated from the registered distance information.

### Second Embodiment

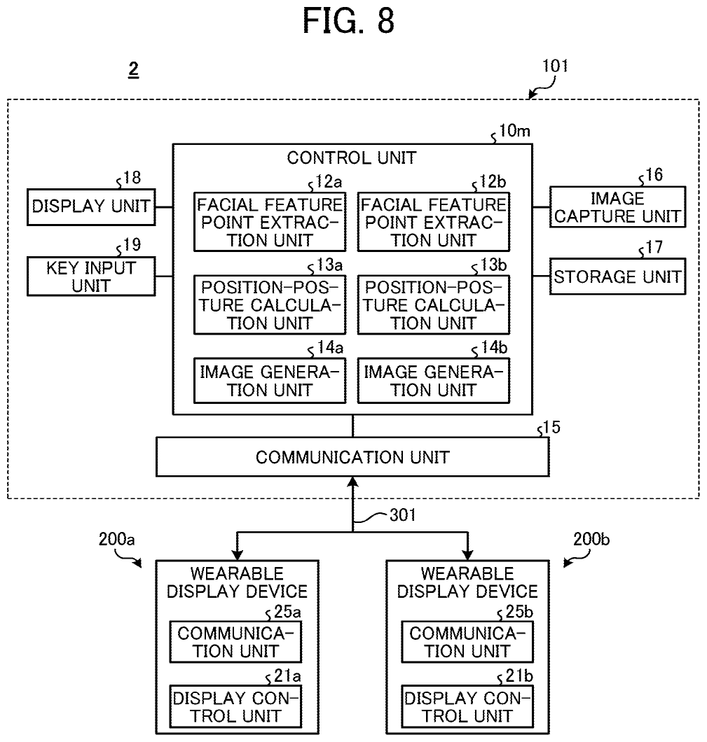

Hereinafter, a description is given of an image display system 2 according to a second embodiment with reference to FIGS. 8 to 10. Different from the first embodiment, as to the image display system 2 of the second embodiment, images are individually displayed and shown to a plurality of users, such as user PSa and user PSb.

### (Functional Configuration of Image Display System)

FIG. 8 illustrates an example of a block diagram of a functional configuration of the image display system 2 according to the second embodiment. As illustrated in FIG. 8, the image display system 2 includes, for example, one information terminal 101, and two wearable display devices 200a and 200b connected to the one information terminals 101.

As illustrated in FIG. 8, the information terminal 101 includes, for example, a control unit 10m employing a configuration different from the configuration of the first embodiment.

The control unit 10m includes, for example, facial feature point extraction units 12a and 12b, position-posture calculation units 13a and 13b, and image generation units 14a and 14b.

The image capture unit 16 of the information terminal 101 simultaneously captures images of two users, and the facial feature point extraction units 12a and 12b, the position-posture calculation units 13a and 13b, and the image generation units 14a and 14b perform the facial feature point extraction, position and posture estimation, and image generation processing in parallel for the respective users.

That is, the facial feature point extraction unit 12a extracts the facial feature point of a user wearing the wearable display device 200a.

The position-posture calculation unit 13a calculates the position and posture of the head of the user wearing the wearable display device 200a based on the facial feature point extracted by the facial feature point extraction unit 12a.

The image generation unit 14a generates an image to be displayed at the wearable display device 200a based on the position-posture information calculated by the position-posture calculation unit 13a.

On the other hand, the facial feature point extraction unit 12b extracts the facial feature point of a user wearing the wearable display device 200b.

The position-posture calculation unit 13b calculates the position and posture of the head of the user wearing the wearable display device 200b based on the facial feature point extracted by the facial feature point extraction unit 12b.

The image generation unit 14b generates an image to be displayed at the wearable display device 200b based on the position-posture information calculated by the position-posture calculation unit 13b.

The communication unit 15 transmits the image data generated by the image generation unit 14a to the communication unit 25a of the wearable display device 200a in real time via the cable 301, such as HDMI cable, and also transmits the image data generated by the image generation unit 14b to the communication unit 25b of the wearable display device 200b in real time via the cable 301, such as HDMI cable.

As illustrated in FIG. 8, the wearable display device 200a includes, for example, a communication unit 25a, and a display control unit 21a. The communication unit 25a receives the image data generated by the image generation unit 14a from the information terminal 101. The display control unit 21a displays the image data received from the information terminal 101.

As illustrated in FIG. 8, the wearable display device 200b includes, for example, a communication unit 25b, and a display control unit 21b. The communication unit 25b receives the image data generated by the image generation unit 14b from the information terminal 101. The display control unit 21b displays the image data received from the information terminal 101.

### (Operation of Image Display System)

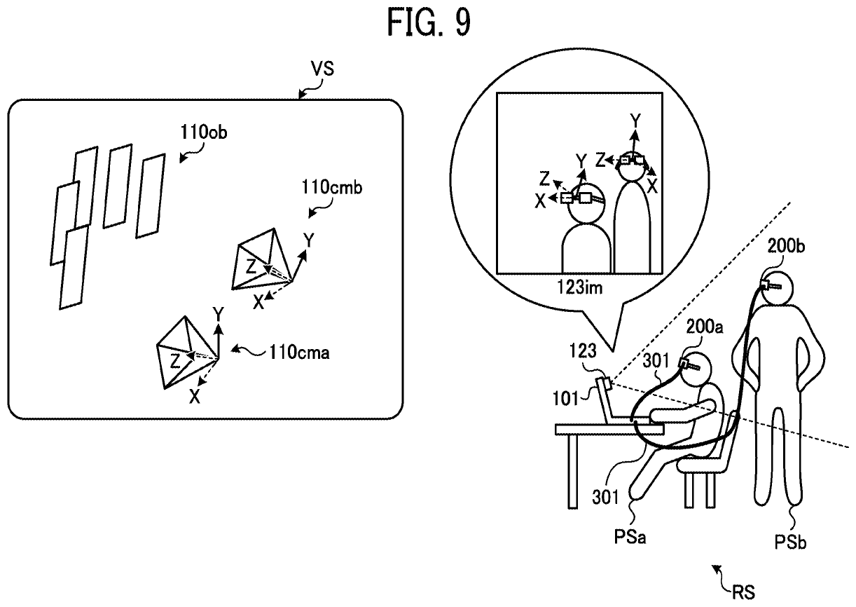

FIG. 9 illustrates an example of operation of the image display system 2 according to the second embodiment. As illustrated in FIG. 9, the user PSa in the image display system 2 wears the wearable display device 200a. Further, the user PSb in the image display system 2 wears the wearable display device 200b.

The information terminal 101 having the camera 123 is disposed at a position where the camera 123 can capture images of faces of the users PSa and PSb, respectively wearing the wearable display devices 200a and 200b, by one-time image capture operation, such as the front side of the users PSa and PSb. The wearable display devices 200a and 200b are connected to the information terminal 101 using the cable 301.

When the image capture unit 16 implemented by the camera 123 captures an image including the faces of the users PSa and PSb as a captured image 123im, the control unit 10m performs the identification of the users PSa and PSb. That is, the wearable display devices 200a and 200b and the users PSa and PSb and PSb are associated with each other. The wearable display devices 200a and 200b and the users PSa and PSb can be associated with each other, for example, by performing the calibration in the same manner as described in the first embodiment in the order instructed by the information terminal 101.

In other words, for example, in accordance with the instructions received from the information terminal 101 for instructing the calibration of the wearable display device 200a, when the user PSa performs the calibration, the face of the user PSa is recognized, and the wearable display device 200a and the user PSa are associated with each other.

Then, in accordance with the instructions received from the information terminal 101 for instructing the calibration of the wearable display device 200b, when the user Psb performs the calibration, the face of the user Psb is recognized, and the wearable display device 200b and the user Psb are associated with each other.

Thereafter, the image capturing operation of the users PSa and PSb by the camera 123 of the information terminal 100 is continued.

The facial feature point extraction units 12a and 12b extract the facial feature point of the respective users PSa and PSb from the face images of respective users PSa and PSb.

The position-posture calculation units 13a and 13b generate the position-posture information of the respective users PSa and PSb from the extracted facial feature point of the respective users PSa and PSb. The extraction of the facial feature point and the estimation of the position and posture performed by the respective facial feature points extraction units 12a and 12b and the respective position-posture calculation units 13a and 13b can be performed, for example, by the same method of the above-described first embodiment.

The respective image generation units 14a and 14b generate the images to be displayed at the respective wearable display devices 200a and 200b based on the position-posture information of the respective users PSa and PSb.

In this case, virtual cameras 110cma and 110cmb are set for the respective users PSa and PSb in the virtual space VS. The position and direction of the virtual camera 110cma is aligned to the position and posture of the user PSa, and the position and direction of the virtual camera 110cmb is aligned to the position and posture of the user Psb. That is, each of the virtual cameras 110cma and 110cmb becomes the viewpoint of the respective users PSa and PSb. With this configuration, the respective users PSa and PSb can observe the same virtual space VS from the respective viewpoints, and can confirm the positions of the respective users PSa and PSb. The position control and image generation performed for the virtual cameras 110cma and 110cmb can be performed by using the function of the Unity application as similar to the first embodiment described above.

As to the image display system 2 of the second embodiment, the estimation of position-posture information of a plurality of persons is performed based on images captured, for example, by one single camera such as the camera 123. With this configuration, it is not required to set the camera 123 for each of the users PSa and PSb, with which the system cost can be reduced, and the installation workload can be reduced.

In the second embodiment described above, the images are displayed on the wearable display devices 200a and 200b for the two users PSa and PSB, but the number of users can be three or more.

### Modification Example

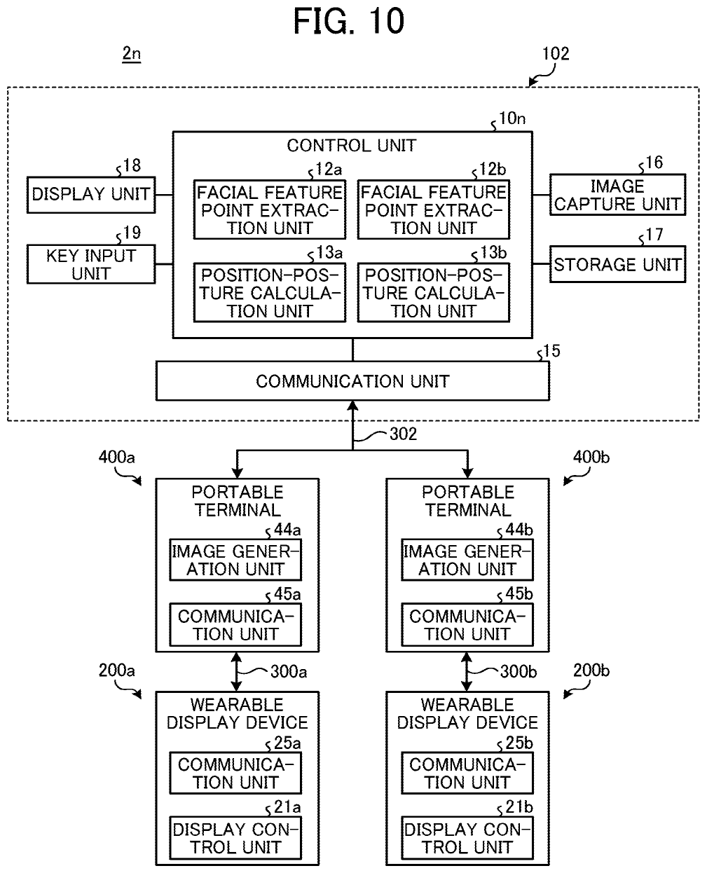

Hereinafter, a description is given of an image display system 2n of a modification example of the second embodiment with reference to FIG. 10. Different from the image display system 2 of the second embodiment described above, the image display system 2n of the modification example includes portable terminals 400a and 400b (portable information terminal) that perform the image generation function.

FIG. 10 illustrates an example of a block diagram of a functional configuration of the image display system 2n according to the modification example of the second embodiment.

As illustrated in FIG. 10, the image display system 2n includes, for example, an information terminal 102, portable terminals 400a and 400b, and wearable display devices 200a and 200b. The information terminal 102 is connected to the portable terminals 400a and 400b via the cable 302. Further, the information terminal 102 can be connected to the portable terminals 400a and 400b wirelessly. The portable terminal 400a is connected to the wearable display device 200a via a cable 300a. The portable terminal 400b is connected to the wearable display device 200b via the cable 300b.

The control unit 10n of the information terminal 102 includes, for example, a facial feature point extraction units 12a and 12b, and position-posture calculation units 13a and 13b, but does not have an image generation function.

The communication unit 15 transmits the position-posture information generated by the position-posture calculation unit 13a to the communication unit 45a of the portable terminal 400a in real time via the cable 302, such as HDMI cable, and also transmits the position-posture information generated by the position-posture calculation unit 13b to the communication unit 45b of the portable terminal 400b in real time via the cable 302, such as HDMI cable.

As illustrated in FIG. 10, the portable terminal 400a includes, for example, an image generation unit 44a, and a communication unit 45a.

The image generation unit 44a generates an image to be displayed at the wearable display device 200a based on the position-posture information generated by the position-posture calculation unit 13a of the information terminal 102.

The communication unit 45a receives the position-posture information generated by the position-posture calculation unit 13a from the communication unit 15 of the information terminal 102. Further, the communication unit 45a transmits image data generated by the image generation unit 44a to the communication unit 25a of the wearable display device 200a in real time.

As illustrated in FIG. 10, the portable terminal 400b includes, for example, an image generation unit 44b, and a communication unit 45b.

The image generation unit 44b generates an image to be displayed at the wearable display device 200b based on the position-posture information generated by the position-posture calculation unit 13b of the information terminal 102.

The communication unit 45b receives the position-posture information generated by the position-posture calculation unit 13b from the communication unit 15 of the information terminal 102. Further, the communication unit 45b transmits image data generated by the image generation unit 44b to the communication unit 25b of the wearable display device 200b in real time.

Each of the wearable display devices 200a and 200b employ a configuration similar to the configuration of the second embodiment described above. However, the communication unit 25a of the wearable display device 200a receives the image data from the portable terminal 400a, and the communication unit 25b of the wearable display device 200b receives the image data from the portable terminal 400b.

As to the image display system 2n of the modification example, the information terminal 102 can be, for example, laptop PC. Further, the portable terminals 400a and 400b can be smartphones or the like carried by the users PSa and PSb, respectively. As above described, the function of generating images based on the position-posture information generated by the information terminal 102 can be performed by the portable terminals 400a and 400b, such as smartphone or the like, carried by the respective users PSa and PSb.

### Third Embodiment

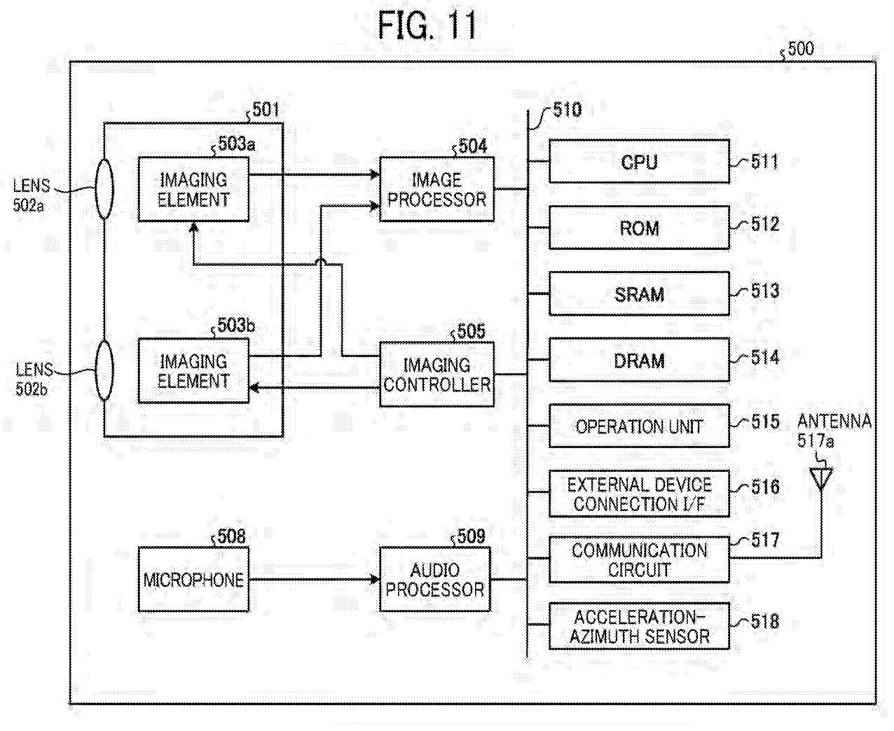

Hereinafter, a description is given of an image display system 3 according to a third embodiment with reference to FIGS. 11 to 14. Different from the first and second embodiments described above, the image display system 3 of the third embodiment includes a full-view spherical image capture apparatus 500 for performing the image capturing operation of the respective users PSa and PSb.

### (Hardware Configuration of Image Display System)

FIG. 11 illustrates an example of a block diagram of a hardware configuration of of the full-view spherical image capture apparatus 500 applied to the image display system 3 according to the third embodiment. In the following description, the full-view spherical image capture apparatus 500 is described as a full-view spherical image (omnidirectional image) capture apparatus using two imaging elements, but the imaging elements can be two or more. Further, the full-view spherical image capture apparatus 500 is not necessarily to be a device exclusively designed for capturing omnidirectional images. For example, a conventional digital camera or a smart phone can be attached with an omnidirectional image capture unit to set the function of the full-view spherical image capture apparatus 500.

As illustrated in FIG. 11, the full-view spherical image capture apparatus 500 includes, for example, an image capture unit 501, an image processing unit 504, an imaging controller 505, a microphone 508, an audio processor 509, a CPU 511, a ROM 512, a static random access memory (SRAM) 513, a dynamic random access memory (DRAM) 514, an operation unit 515, an external device connection interface (I/F) 516, a communication circuit 517, and an acceleration-azimuth sensor 518.

The image capture unit 501 is provided with two wide-angle lenses 502a and 502b respectively having an angle of 180 degrees or more, and two imaging elements 503a and 503b are provided respectively for the correspondence wide-angle lenses 502a and 502b. Each of the wide-angle lenses 502a and 502b is a fish-eye lens or the like which forms a hemispherical image.

Each of the imaging elements 503a and 503b includes, for example, an image sensor, such as complementary metal oxide semiconductor (CMOS) sensor, or charge coupled device (CCD) sensor, that converts optical images formed by the wide-angle lenses 502a and 502b into electric signal image data, and outputs the electric signal image data, a timing generation circuit that generates a horizontal or vertical synchronization signal and an image clock of the image sensor, and a register group setting various commands and parameters required for the operation of the imaging elements 503a and 503b.

Each of the imaging elements 503a and 503b of the image capture unit 501 is connected to the image processing unit 504 using a parallel I/F bus. Each of the imaging elements 503a and 503b is connected to the imaging controller 505 using a serial I/F bus, such as inter-integrated circuit (I2C) bus.

The image processing unit 504, the imaging controller 505, and the audio processor 509 are connected to the CPU 511 via a bus 510. Further, the bus 510 is connected to the ROM 512, SRAM 513, DRAM 514, operation unit 515, external device connection I/F 516, communication circuit 517, and acceleration-azimuth sensor 518.

The image processing unit 504 acquires image data output from the imaging elements 503a and 503b via the parallel I/F bus, performs given processing on each image data, synthesizes the image data, and then creates data of equirectangular projection image.

As to the full-view spherical image capture apparatus 500, the imaging controller 505 is used as a master device, and the imaging elements 503a and 503b is used as slave devices, in which the imaging controller 505 sets commands in the register group of the imaging elements 503a and 503b using the serial I/F bus. The required commands are received from the CPU 511. Further, the imaging controller 505 also uses the serial I/F bus to acquire the status data of the register group of the imaging elements 503a and 503b, and then transmits status data of the register group of the imaging elements 503a and 503b to the CPU 511.

Further, the imaging controller 505 instructs the imaging elements 503a and 503b to output the image data at the timing when a shutter button of the operation unit 515 is pressed.

Further, the full-view spherical image capture apparatus 500 may have a function corresponding to a preview display function or a video display function using a display of smart phone or the like. In this case, the output of the image data from the imaging elements 503a and 503b is continuously performed with a given frame rate (frame per minute).

Further, the imaging controller 505 also functions as a synchronization control unit for synchronizing an output timing of image data of the imaging elements 503a and 503b in cooperation with the CPU 511, to be described later. In the third embodiment, a display device, such as a display, is not installed on the full-view spherical image capture apparatus 500, but a display device may be installed on for the full-view spherical image capture apparatus 500.

The microphone 508 converts the collected audio into audio (signal) data. The audio processor 509 acquires the audio data output from the microphone 508 through the I/F bus, and performs given processing on the audio data.

The CPU 511 controls the operation of the full-view spherical image capture apparatus 500 entirely to perform the required processing. The ROM 512 stores various programs executable by the CPU 511. The SRAM 513 and DRAM 514 are used as work memory, and stores programs executed by the CPU 511 and data during the processing performed by the CPU 511. In particular, the DRAM 514 stores image data during the processing performed by the image processing unit 504, and the processed data of equirectangular projection image.

The operation unit 515 is a collective name of operation buttons, including a shutter button. A user operates the operation unit 515 to input various image capture modes and image capture conditions.

The external device connection I/F 516 is an interface for connecting to various external devices. The external device includes, for example, universal serial bus (USB) memory and PC. The data of equirectangular projection image stored in the DRAM 514 can be recorded on an externally removeable recording medium via the external device connection I/F 516, or can be transmitted to an external terminal, such as smartphone or the like via the external device connection I/F 516 as needed.

The communication circuit 517 communicates with the external terminal, such as smart phone or the like, via the antenna 517a provided for the full-view spherical image capture apparatus 500 using short-range communication technology such as Wi-Fi (registered trademark), near field communication NFC), and Bluetooth (registered trademark). The data of equirectangular projection image can be transmitted to the external terminal, such as smartphone, using the communication circuit 517.

The acceleration-azimuth sensor 518 calculates the azimuth of the full-view spherical image capture apparatus 500 based on the magnetic field of the earth, and outputs the azimuth information. The azimuth or bearing information is an example of related information, such as metadata for exchangeable image file format (Exif), and can be used for image processing, such as image correction of the captured image. The related information includes, for example, data on date and time of the image capturing operation, and data amount of the image data.

Further, the acceleration-azimuth sensor 518 is a sensor that detects a change of angles, such as roll angle, pitch angle, and yaw angle, associated with a movement of the full-view spherical image capture apparatus 500. The change of angle is an example of related information, such as metadata for Exif, and can be used for image processing, such as image correction of the captured image.

Furthermore, the acceleration-azimuth sensor 518 is a sensor that detects acceleration in the three axial directions. The full-view spherical image capture apparatus 500 calculates the posture of the full-view spherical image capture apparatus 500, that is an angle with respect to the gravity direction, based on the acceleration detected by the acceleration-azimuth sensor 518. The accuracy of image correction can be improved by providing the acceleration-azimuth sensor 518 in the full-view spherical image capture apparatus 500.

### (Functional Configuration of Image Display System)

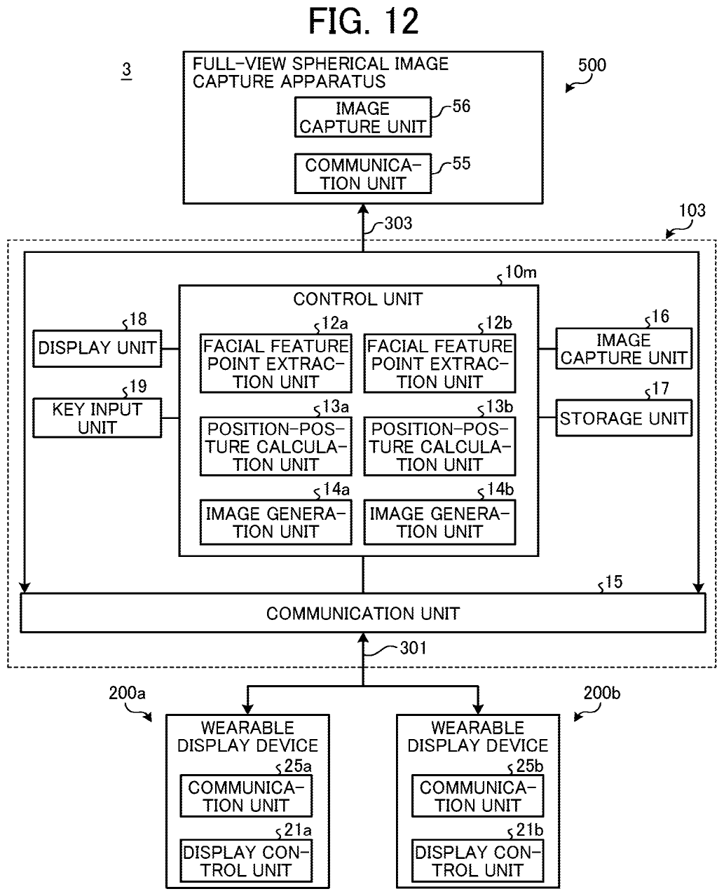

FIG. 12 illustrates an example of a block diagram of a functional configuration of the image display system 3 according to the third embodiment. As illustrated in FIG. 12, the image display system 3 includes, for example, the full-view spherical image capture apparatus 500, an information terminal 103, wearable display devices 200a and 200b.

As illustrated in FIG. 12, the full-view spherical image capture apparatus 500 includes, for example, a communication unit 55, and an image capture unit 56.

The image capture unit 56 captures, for example, image of a plurality of users by one-time image capture operation, and generates data of equirectangular projection image. The image capture unit 56 is implemented by, for example, the image capture unit 501, the image processing unit 504, the imaging controller 505 of FIG. 11, and the programs executed by the CPU 211.

The communication unit 55 transmits the data of equirectangular projection image generated by the image capture unit 56 to the communication unit 15 of the information terminal 103 in real time, for example, via a cable 303, such as HDMI cable. Further, the communication unit 55 may transmit the data of equirectangular projection image to the communication unit 15 of the information terminal 103 wirelessly. The communication unit 55 is implemented, for example, by the external device connection I/F 516, the communication circuit 517, and the antenna 517a of FIG. 11.

As illustrated in FIG. 12, the information terminal 103 includes, for example, a control unit 10m. The control unit 10m employs a configuration similar to the configuration of the second embodiment described above. However, the information terminal 103 extracts the facial feature point of each user from the data of equirectangular projection image captured by the full-view spherical image capture apparatus 500, estimates the position and posture, and generates images to be displayed at the wearable display devices 200a and 200b. The communication unit 15 of the information terminal 103 receives the data of equirectangular projection image from the communication unit 55 of the full-view spherical image capture apparatus 500 via the cable 303 or wirelessly. Further, the information terminal 103 may be provided with an image capture unit, but is not used in the third embodiment.

Each of the wearable display devices 200a and 200b employs a configuration similar to the configuration of the second embodiment described above.

### (Operation of Image Display System)

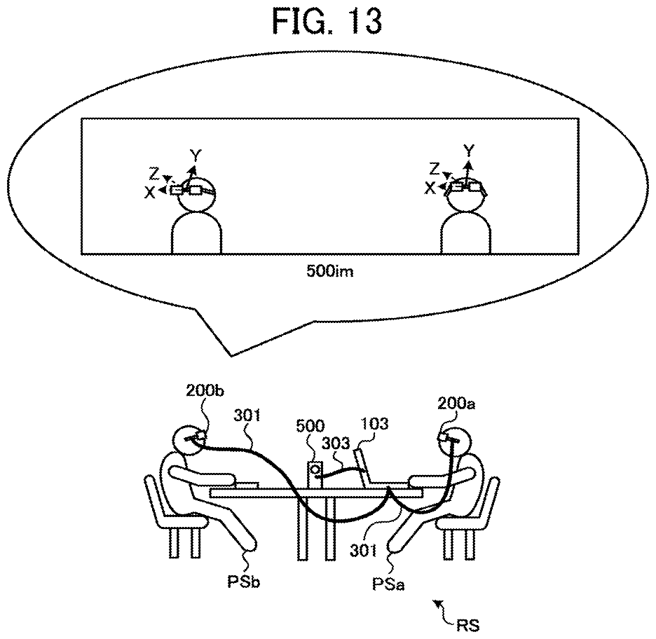

FIG. 13 illustrates an example of operation of the image display system 3 according to the third embodiment. As illustrated in FIG. 13, as to the image display system 3, the respective users PSa and PSb wearing the wearable display devices 200a and 200b, respectively, take seats at the opposed sides of a table by setting the full-view spherical image capture apparatus 500, for example, at a given position between the users PSa and PSb. By setting the full-view spherical image capture apparatus 500 between the users PSa and PSb, the face images of the respective users PSa and PSb can be captured simultaneously from, for example, the front side while the users PSa and PSb facing each other.

Based on data 500im of equirectangular projection image generated by the full-view spherical image capture apparatus 500, the extraction of the facial feature point, the estimation of the position and posture of the users PSa and PSb, the generation of images to be displayed at each of the wearable display devices 200a and 200b can be processed in parallel. The generated images are output to the respective wearable display devices 200a and 200b in real time via the cable 301 that connects the information terminal 103 and the wearable display devices 200a and 200b.

As to the image display system 3 of the third embodiment, the full-view spherical image capture apparatus 500 is used. With this configuration, an image capturable range of the users PSa and PSb can be set to 360 degrees, with which a range where the users PSa and PSb and PSb can act or move in the real space can be set greater than a range where the users PSa and PSb and PSb can act or move in the real space using an angle of view of general camera.

Further, in the third embodiment, the number of user is two users PSa and PSb, but the number of user members can be three or more.

### Modification Example

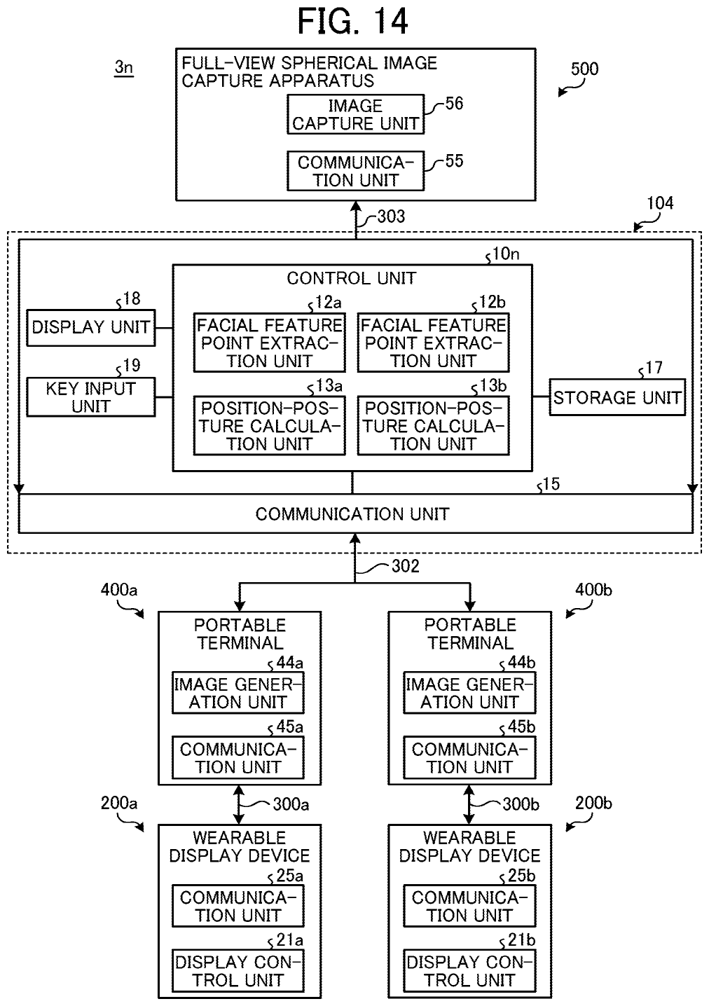

FIG. 14 illustrates an example of a block diagram of a functional configuration of the image display system 3n according to a modification example of the third embodiment. As illustrated in FIG. 14, the configuration includes the full-view spherical image capture apparatus 500, but the image generation function can be performed by the portable terminals 400a and 400b.

In other words, the image display system 3n includes, for example, the full-view spherical image capture apparatus 500, an information terminal 104, portable terminals 400a and 400b, and wearable display devices 200a and 200b.

The full-view spherical image capture apparatus 500 employs a configuration similar to the configuration of the third embodiment described above.

As illustrated in FIG. 14, the information terminal 104 includes, for example, a control unit 10n. The control unit 10n employs a configuration similar to the configuration of the configuration of the second embodiment described above. The information terminal 104 may be provided with an image capture unit, but is not used in the third embodiment.

The wearable display device 200a and 200b employs a configuration similar to the configuration of the second embodiment described above.

### Fourth Embodiment

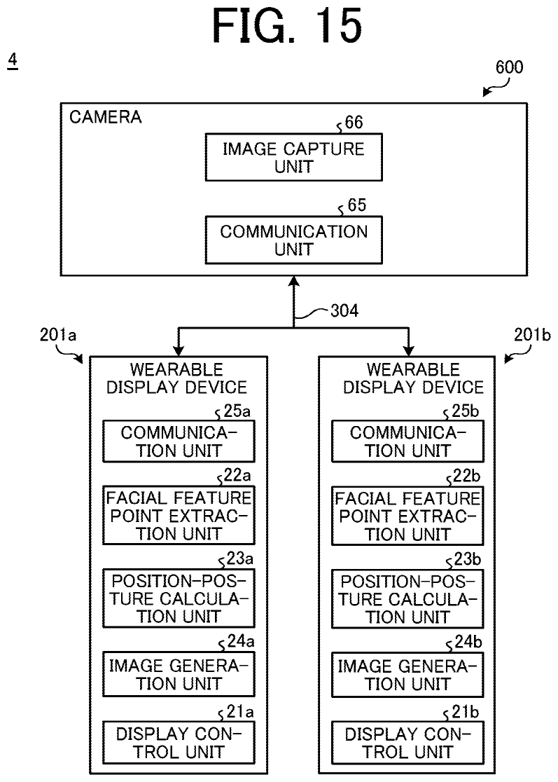

In the above described first to third embodiments and the modified examples thereof, the information terminal 100 and the portable terminals 400a and 400b perform the face feature point extraction function, the position and posture estimation function, and the image generation function, but these functions may be provided to the wearable display device 200. FIG. 15 illustrates an example of a fourth embodiment.

FIG. 15 illustrates an example of a block diagram of a functional configuration of an image display system 4 according to a fourth embodiment. As illustrated in FIG. 15, the image display system 4 includes, for example, a camera 600, and wearable display devices 201a and 201b. The camera 600 and the wearable display devices 201a and 201b are connected, for example, by a cable 304.

The camera 600 can be, for example, digital camera, such as RGB camera, RGB-D camera, and stereo camera, and the above-described full-view spherical image capture apparatus 500.

The camera 600 includes, for example, a communication unit 65, and an image capture unit 66. The image capture unit 66 captures images including a face of user. The communication unit 65 transmits images captured by the image capture unit 66 to the communication units 25a and 25b of the wearable display devices 201a and 201b via the cable 304, such as HDMI cable, or wirelessly.

As illustrated in FIG. 15, the wearable display device 201a includes, for example, a display control unit 21a, a facial feature point extraction unit 22a, a position-posture calculation unit 23a, an image generation unit 24a, and a communication unit 25a.

The facial feature point extraction unit 22a extracts the facial feature point of a user wearing the wearable display device 201a.

The position-posture calculation unit 23a generates position-posture information of the user based on the facial feature point of the user who wearing the wearable display device 201a.

The image generation unit 24a generates an image to be displayed at the wearable display device 201a based on the position-posture information of the user wearing the wearable display device 201a.

The display control unit 21a displays the image generated by the image generation unit 24a to show the image to the user.

As illustrated in FIG. 15, the wearable display device 201b includes, for example, a display control unit 21b, a facial feature point extraction unit 22b, a position-posture calculation unit 23b, an image generation unit 24b, and a communication unit 25b.

The facial feature point extraction unit 22b extracts the facial feature point of a user wearing the wearable display device 201b.

The position-posture calculation unit 23b generates position-posture information of the user based on the facial feature point of the user wearing the wearable display device 201b.

The image generation unit 24b generates an image to be displayed at the wearable display device 201b based on the position-posture information of the user wearing the wearable display device 201b.

The display control unit 21b displays the image generated by the image generation unit 24b to show the image to the user.

As to the fourth embodiment, the image display system 4 can attain at least any one of the effects of the above described first, second and third embodiments, and the modification examples thereof.

As to the image display system 4, the number of user may be one, or three or more.

As to the above described one or more embodiments, the image display system, image display apparatus, image display method, program, wearable display device, which can display images at the wearable display device can be provided with less restrictions on design configuration.

In the above described first, second and third embodiments and the modification examples thereof, for example, the information terminal 100 and the portable terminals 400a and 400b perform the face feature point extraction function, the position and posture estimation function, and the image generation function, but the facial feature point extraction function may be included in the image capture unit 16. In this case, a terminal having the position-posture calculation function, which calculates the position and posture of head of person based on the facial feature point, may have a facial feature point input unit, to which the facial feature point are input from the image capture unit.

Numerous additional modifications and variations are possible in light of the above teachings. It is therefore to be understood that, within the scope of the appended claims, the disclosure of this specification can be practiced otherwise than as specifically described herein. Any one of the above-described operations may be performed in various other ways, for example, in an order different from the one described above.

For example, the image display systems of the above described first, second, third and fourth embodiments may be operated by operating the CPU in accordance with one or more programs, and can be implemented using hardware resources such as an application specific integrated circuit (ASIC) having the same functions and control functions that the program performs.

Each of the functions of the above-described embodiments can be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), system on a chip (SOC), graphics processing unit (GPU), and conventional circuit components arranged to perform the recited functions.

What is claimed is:

1. An image display system comprising:
a wearable display device configured to display an image to a person wearing the wearable display device, the wearable display device mountable on a head of the person;
an image capture unit configured to capture an image of a face of the person wearing the wearable display device; and
circuitry configured to
extract one or more facial feature points of the person based on the image captured by the image capture unit;
calculate a position of the head of the person and a posture of the person based on the one or more extracted facial feature points to generate position-posture information; and
generate an image to be displayed at the wearable display device based on the position-posture information.

2. The image display system of claim 1,
wherein the wearable display device is a transparent wearable display device.

3. The image display system of claim 1,
wherein the wearable display device displays an augmented reality image that combines a real space image and a virtual space image.

4. The image display system of claim 1,
wherein the circuitry extracts one or more feature points excluding an area including an eye, among the one or more feature points of face organs consisting the face of the person.

5. The image display system of claim 1,
wherein the circuitry determines an angle of view, a position, and a direction of a virtual camera in a virtual space based on a viewing angle of the wearable display device and the position-posture information of the person, and generates an image to be displayed at the wearable display device based on the determined angle of view, position, and direction of the virtual camera.

6. The image display system of claim 1,
wherein the wearable display device includes a first wearable display device configured to display an image to a first person wearing the first wearable display device, and a second wearable display device configured to display an image to a second person wearing the second wearable display device,
wherein the image capture unit captures a face of the first person wearing the first wearable display device, and a face of the second person wearing the second wearable display device simultaneously,
wherein the circuitry is configured to extract one or more facial feature points of the first person based on the image captured by the image capture unit, and to extract one or more facial feature points of the second person based on the image captured by the image capture unit,
wherein the circuitry is configured to calculate a position of a head of the first person and a posture of the first person based on the one or more facial feature points of the first person to generate position-posture information of the first person, and to calculate a position of a head of the second person and a posture of the second person based on the one or more facial feature points of the second person to generate position-posture information of the second person,
wherein the circuitry is configured to generate an image to be displayed at the first wearable display device based on the calculated position-posture information of the first person, and to generate an image to be displayed at the second wearable display device based on the calculated position-posture information of the second person.

7. The image display system of claim 1,
wherein the image capture unit is a full-view spherical image capture apparatus capable of capturing an omnidirectional image by one image capturing operation.

8. The image display system of claim 1,
wherein the image capture unit is a portable terminal having a function of capturing images.

9. A method of displaying an image comprising:
extracting one or more facial feature points of a person wearing a wearable display device based on an image captured by an image capture unit;
calculating a position of a head of the person and a posture of the person based on the one or more extracted facial feature points to generate position-posture information; and
generating an image to be displayed at the wearable display device based on the calculated position-posture information including position information of the head of the person and posture information of the person.

10. A wearable display device comprising:
circuitry configured to
calculate a position of a head of a person and a posture of the person based on one or more facial feature points of the person wearing the wearable display device, based on an image captured by an image capture unit to generate position-posture information;
generate an image to be displayed at the wearable display device based on the calculated position-posture information; and
display the generated image, on a display.

11. The wearable display device of claim 10,
wherein the circuitry extracts the one or more facial feature points of the person wearing the wearable display device based on the image captured by the image capture unit

12. The wearable display device of claim 10,
wherein the circuitry receives the one or more facial feature points of the person wearing the wearable display device, extracted from the image captured by the image capture unit.
